(19) United States
(12) Patent Application Publication
(10) Pub. No.: US 2026/0162034 A1
(43) Pub. Date: Jun. 11, 2026

(54) SYSTEMS AND METHODS FOR AUTOMATED DISPATCH OF AND LOAD ASSIGNMENT FOR MOTOR CARRIERS

(71) Applicant: TrueNorth Technologies Inc., San Francisco, CA (US)

(72) Inventors: Eric Harrison, San Francisco, CA (US); Greg Cooper, San Francisco, CA (US); Aswin Nair, San Francisco, CA (US); Jonathan Kimball, San Francisco, CA (US); James Chanler, San Francisco, CA (US); Ethan Andrews, San Francisco, CA (US); Ian Roughley, San Francisco, CA (US); Sanjaya Wijeratne, San Francisco, CA (US); Jin Stedge, San Francisco, CA (US); Michael Davidian, San Francisco, CA (US)

(21) Appl. No.: 19/410,554

(22) Filed: Dec. 5, 2025

Related U.S. Application Data
(60) Provisional application No. 63/729,245, filed on Dec. 6, 2024.

(51) Int. Cl. G06Q 10/0631; G06F 16/3329; H04W 4/14; H04W 4/44

(52) U.S. Cl. CPC G06Q 10/06312; G06F 16/3329; H04W 4/14; H04W 4/44

(57) ABSTRACT

A method for automated load assignment and/or dispatch for motor carriers is presented. The method can include providing, a virtual dispatcher having a plurality of modules, each module configured to interface with an artificial intelligence (AI) system to perform a task specific to each module. The method can include receiving, using the virtual dispatcher, load preferences from a motor carrier and load information from a freight broker. The method can include determining, using the virtual dispatcher, a load assignment using the load preferences, the load information, and the AI system that interfaces with the virtual dispatcher. The method can include generating, using the virtual dispatcher, a dispatch response using the load assignment and the AI system. The method can include relaying, using the virtual dispatcher, the dispatch response to the motor carrier.

### CROSS-REFERENCE TO RELATED APPLICATIONS

This application claims priority to and the benefit of U.S. Provisional Application No. 63/729,245 titled “Systems and Methods for Automated Dispatch of and Load Assignment for Motor Carriers” and filed Dec. 6, 2024 which is incorporated herein by reference in its entirety.

### TECHNICAL FIELD

The present disclosure generally relates to systems and methods for automated dispatch of and load assignment for motor carriers. More specifically, the present disclosure relates to methods, e.g., computer-implemented methods, for automated dispatch of motor carriers, and automated systems for assigning loads offered by freight brokers to motor carriers that may haul such loads.

### BACKGROUND

Conventional dispatching systems and techniques are generally operated manually. For example, a human dispatcher can call a motor carrier to request their route preferences in preparation for the motor carrier's next load. This process can be time intensive to the human dispatcher if there are many motor carriers to reach, and prone to human error of the human dispatcher when collecting the route preference information from the motor carriers. In addition, conventional dispatching systems and techniques can be limited to performing load searches and providing delivery instructions manually as well.

The foregoing discussion, including the description of motivations for some embodiments of the invention, is intended to assist the reader in understanding the present disclosure, is not admitted to be prior art, and does not in any way limit the scope of any of the claims.

### SUMMARY

A method for automated load assignment and/or dispatch for motor carriers is presented. In some embodiments, the method can include providing, a virtual dispatcher having a plurality of modules, each module configured to interface with an artificial intelligence (AI) system to perform a task specific to each module. In some embodiments, the virtual dispatcher can include artificial intelligence algorithms, machine learning algorithms, neural network algorithms, reinforcement learning algorithms, among other algorithms. In an example, the virtual dispatcher can include and/or be referred to herein as an artificial intelligence (AI) dispatcher. In one example, the virtual dispatcher and the AI system can be separate systems. In another example, the virtual dispatcher and the AI system can be combined and/or part of the same AI system. In some examples, the method can include receiving, using the virtual dispatcher, load preferences from a motor carrier and load information from a freight broker. As described herein, freight brokers can be referred to as brokers, among other terms. As described herein, motor carriers can be referred to as carriers, among other terms. The method can include determining, using the virtual dispatcher, a load assignment using the load preferences, the load information, and the AI system that interfaces with the virtual dispatcher. The method can include generating, using the virtual dispatcher, a dispatch response using the load assignment and the AI system. The method can include relaying and/or transmitting, using the virtual dispatcher, the dispatch response to the motor carrier. In some examples, relaying the dispatch response to the motor carrier can include relaying, using the virtual dispatcher, the AI system, computing devices, and engagement platform, the dispatch response to the motor carrier. As used herein, load preferences can include carrier load preferences, and/or carrier preferences for shipping or hauling loads. As used herein, load information can include descriptive information about one or more loads, e.g., as provided by freight brokers. In some examples, the method for automated load assignment for motor carriers and/or the dispatch response can include providing load recommendations or load promotions to motor carriers. In some examples, the method for automated load assignment for motor carriers and/or the dispatch response can include connecting motor carriers that are interested in a load with the freight broker for the load. In some examples, connecting motor carriers and brokers can include the virtual dispatcher negotiating, booking or discussing the load on behalf of the motor carrier or broker.

Various embodiments of the method can include one or more of the following steps.

In some embodiments, the method can include selecting, by the virtual dispatcher, at least one module of a plurality of modules using the load preferences, the load information, and AI system, where the selecting is performed prior to determining the load assignment. In some examples, the AI system can include using or training a large language model (LLM), a large multimodal model (LMM) and/or an algorithm. The at least one module can include a carrier availability module, and where AI systems determine the availability of the motor carrier and store availability to a database. Determining the load assignment can include storing, using the carrier availability module and the load request module, the load preferences including the availability of the motor carrier to the database using the load preferences, and AI system. The at least one module can include a load request module, and where AI system compares the load preferences provided by the motor carriers against a list of potential loads included in the load information from the freight brokers. The at least one module can include a load request module, and where AI system compares the load information provided by the freight brokers against a list of potential carriers. Determining the load assignment can include (i) comparing, using the load request module, the load preferences and load information including the list of potential loads using the load preferences, load information, motor carrier availability, and AI system, (ii) identifying, using the load request module, the availability of a load for delivery from the list of potential loads using the comparison between the load preferences, the load information, motor carrier availability, and AI system, and (iii) using the load availability module and the load preferences to find a number of load options and utilizing the customer engagement platform to present the carrier with load options to choose from. The at least one module can include a load availability module, and where AI system can search for an available load from a load board or other source of loads. In an example, the at least one module includes a load availability module, and where AI system can search for an available carrier from a list of potential carriers. Determining the load assignment can include searching, using the load availability module, for a load on the load board or other source of loads that matches the load preferences using the load information and AI system. In some examples, determining the load assignment can include requesting, using the load availability module, load information of a load from a freight broker, where the load information includes availability of the load. In an example, the load information can include “load not available”, “load available”, or similar information. The load information can include when the load will become available, among other load information. The at least one module can include a load aggregator, and AI system to generate a list of potential loads. The at least one module can include a load fetcher, and AI system to iteratively update a load list from a load board or other source of loads. The load preferences can include at least one of a carrier pick-up schedule, a carrier equipment, a carrier origin location, a preferred delivery destination, pickup location, pick up time, load type, possible destination, or a carrier route preference. The load information can include at least one of a load pick-up schedule, a load delivery schedule, a load origin, a load destination, a load type, or a load payment offer.

A system for automated load assignment and/or dispatch for motor carriers is presented. In some embodiments, the system can include a virtual dispatcher that receives (i) load preferences from a motor carrier and (ii) load information from a freight broker, the virtual dispatcher having a plurality of modules, wherein each module is configured to interface with an artificial intelligence (AI) system to perform a task specific to each module. In some examples, the system can include a carrier availability module of the plurality of modules that stores the load preferences to a database using the load preferences and AI system. The system can include a load request module that (i) compares the load preferences and load information using the load preferences, load information, and AI system, and (ii) identifies available loads for delivery from a list of potential loads using the comparison between the load preferences and the load information, and AI system. The system can include a load availability module that searches a load board or other source of loads for available loads that match the load information, using the load information and AI system. In some embodiments, the customer engagement module will present load options to the carrier to choose a load to proceed to load assignment. In some embodiments, the virtual dispatcher can be configured to negotiate and book a load based on preferences received from motor carriers. In some examples, the preferences received from the motor carriers can include at least one of a starting price, a target price, an increment, a go no higher than price, among others.

Various embodiments of the system can include one or more of the following features.

In some embodiments, the AI system includes a large language model (LLM), a large multimodal model (LMM) and/or an algorithm. In some examples, the system can include a database that stores the load preferences of the motor carriers. The system can include one or more load boards or other sources of loads that contain, provide or store information regarding one or more loads, and which can contain, provide or store lists of loads and load information. In some embodiments, the load information from the load boards or other sources of loads can be stored in a database or can be retained locally. The system can include a load aggregator of the plurality of modules that generates a potential loads list stored in a loads cache using the load information, a list of available loads from the load board or other source of loads, and the AI system. The system can include a load fetcher that iteratively updates the potential load list. The AI system can include a speech-to-text generator and/or a text-to-speech generator. The text-to-speech generator can receive a load assignment as input from the virtual dispatcher, and transmit an audio output of the load assignment to the motor carrier. In an example, the text-to-speech generator and/or the speech-to-text generator can interface with the motor carriers, brokers, among other users.

### BRIEF DESCRIPTION OF THE DRAWINGS

The accompanying figures, which are included as part of the present specification, illustrate the presently preferred embodiments, and together with the general description given above and the detailed description of the preferred embodiments given below, serve to explain and teach the principles described herein. Furthermore, like reference numbers refer to similar or the same components within the figures.

FIG. 1 illustrates an automated dispatch and load assignment system, according to some embodiments.

FIGS. 2A and 2B illustrate a flowchart depicting a method for dispatching and assigning loads to motor carriers, according to some embodiments.

FIG. 3 illustrates a diagram of an exemplary hardware and software system implementing the systems and methods described herein, according to some embodiments.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

Systems and methods for dispatching of and assigning loads for motor carriers are presented herein. In some embodiments, the systems and methods presented herein provide for a virtual dispatcher that can receive load preferences from a motor carrier in preparation for the motor carrier's next load. The virtual dispatcher can provide automated load recommendations or load promotions to the motor carriers based on, but not limited to, the load preferences provided by the motor carrier. A load can include goods to be transported from one location to another. Furthermore, the virtual dispatcher can receive load availability and offers from freight brokers, and/or provide the availability of motor carriers to freight brokers. In one example, load preferences can include route preferences of the motor carriers. In some examples, the load preferences can include at least one of a carrier pick-up schedule, a carrier equipment, a carrier origin location, a preferred delivery destination, pickup location, pick up time, load type, possible destination, or a carrier route preference. As used herein, the virtual dispatcher can be referred to as an AI dispatcher, artificial intelligence dispatcher or digital dispatcher, among other terms. As used herein, the freight brokers can be referred to as brokers, among other terms. In some embodiments, the freight broker may be another type of organization, entity or person seeking to transport a load, including the shipper directly (and thus not using a broker). In some embodiments, the method can include (i) receiving loads from freight brokers, (ii) matching, using a virtual dispatcher and an AI system, the loads to motor carriers based on carrier load preferences and the load information provided by freight brokers, and (iii) proactively communicating with the motor carriers to initiate the automated load assignment.

In some embodiments and as described herein, a load assignment and/or dispatch response can include recommending loads to motor carriers, promoting loads to motor carriers, matching motor carriers to loads and informing motor carriers about those loads. In some embodiments and as described herein, a load assignment and/or dispatch response can include connecting motor carriers that are interested in the load with the broker for the load via phone/voice call, short messaging service (SMS)/text messaging, email or computing devices in order to negotiate, book or discuss the load, among other reasons. In some examples, the load assignment does not imply that motor carriers must accept or haul a load.

In some embodiments, the systems and methods presented herein can be configured to perform automated load searches, and based on the results of the performed load searches, automatically provide dispatch instructions or suggestions to the motor carriers via artificial intelligence systems or through one or more computing devices. Furthermore, in some embodiments, the systems and methods can provide for grouping and/or stringing successive loads together. In some examples, the systems and methods can provide recommendations to the motor carriers on how to manage current and future loads based on load forecasting information, driver information, and current load information, among other information. The load information can include at least one of a load pick-up schedule, a load delivery schedule, a load origin, a load destination, a load type, or a load payment offer. In one non-limiting example, based on load preferences received from a motor carrier, the systems and methods can (1) automatically search for, and/or determine loads that meet a motor carrier's preference, (2) have a call with the motor carrier and inform the motor carrier of recommended loads based on the determination, (3) provide the results to the motor carrier along with recommended delivery actions based on the determination, (4) inform the motor carrier of the recommended delivery action, and (5) connect the motor carrier with the broker for the load via phone/voice call, SMS/text messaging, email or computing devices.

In some embodiments, as described herein, motor carriers can include individuals, organizations, and/or companies engaged in transporting goods for hire. In some examples, motor carriers can include individuals, organizations, and/or companies authorized by the U.S. Department of Transportation to transport goods, motor carriers that transport goods interstate, and motor carriers that transport goods intrastate. In some examples, the motor carriers can include drivers, and/or vehicles associated with the motor carriers. In some embodiments, the vehicles associated with and/or used by the motor carriers can include freight trucks, long-haul trucks, 18 wheeler trucks, less-than-truckload (LTL) trucks, tractor trailer trucks, box trucks, straight trucks, sprinter vans, “hot shot” vehicles, among other trucks. The vehicles can also include flatbed freight trucks, drop deck freight trucks, reefer freight trucks, dry van freight trucks, box freight trucks, semi-trailer freight trucks, among other freight trucks. As used herein motor carriers can be referred to as carriers, among other terms.

### Automated Dispatch and Load Assignment System

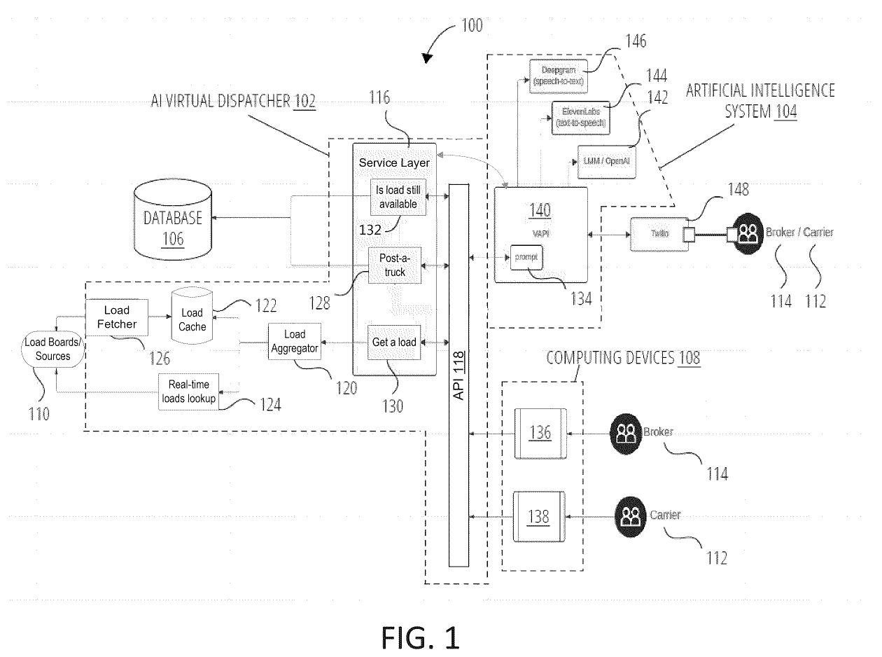

Referring to FIG. 1, an automated dispatch and load assignment system 100 is shown, according to some embodiments. In some embodiments, the automated dispatch system 100 can include a virtual dispatcher 102, an artificial intelligence system 104 (AI), a database 106, computing devices 108, and load boards or other source of loads 110, among other components. The virtual dispatcher 102 can be configured to receive load preferences from motor carriers 112, provide motor carrier availability to freight brokers 114, and provide automated load recommendations or load promotions to the motor carriers 112 from freight brokers 114 and/or load boards or other sources of loads 110. The load preferences can include an availability of each of the motor carriers 112 to pick-up a load for delivery, a preferred schedule to pick-up the load, carrier equipment, origin of the carrier, preferred destination, carrier hours of service, driver experience, carrier route preferences, among other preferences. In some embodiments, the load preferences may include structured information extracted from the received data.

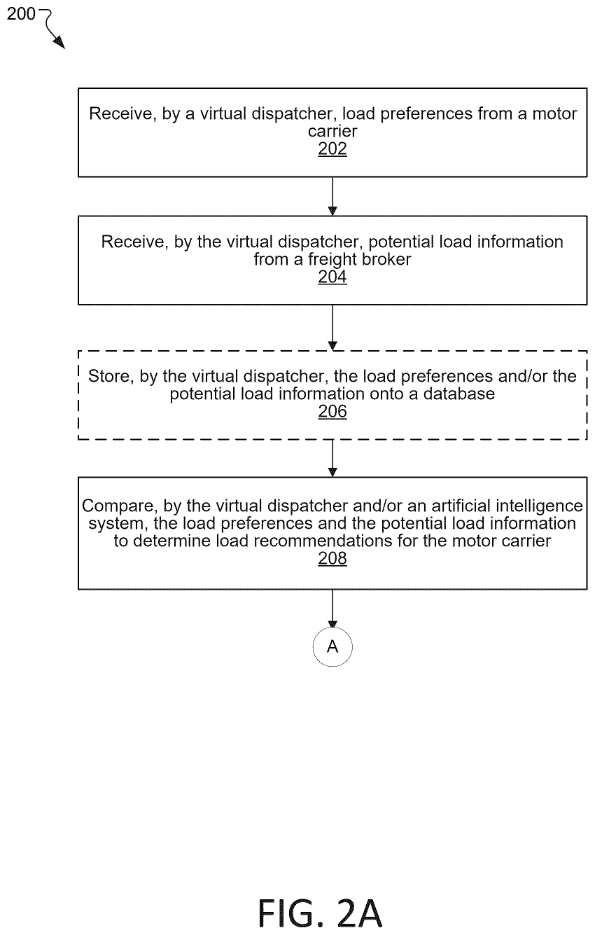

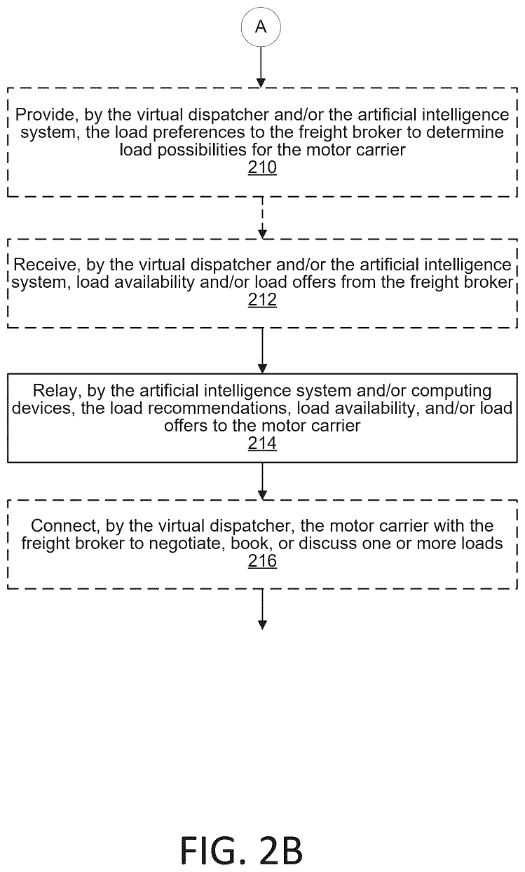

In some embodiments, the virtual dispatcher 102 can include a computer system having a service layer 116, an application programming interface 118, a load aggregator 120, a load cache 122, a real-time load look-up 124, a load fetcher 126, among other components. The service layer 116 of the virtual dispatcher 102 can include a plurality of modules: a post-a-truck module 128, a get-a-load module 130, a module configured to determine whether a load is still available 132, among other modules. It should be noted that not all modules of the virtual displayer 102 are explicitly depicted in FIG. 1 for clarity. For example, the other modules, such as a load request module or a load preference module, may be part of the disclosed system to perform specific functions even if they are not shown in FIG. 1. The database 106 can include one or more databases for storing data, e.g., load preferences and other information, of the motor carriers 112. In some embodiments, the virtual dispatcher (AI dispatcher) 102 can interface with each of the plurality of modules, e.g., modules 128, 130, 132, to perform actions (e.g., the method 200 in FIGS. 2A and 2B) and interpret and/or interact with motor carrier and/or freight broker users via voice, chat, and/or a mobile or web application.

In some embodiments, the artificial intelligence system 104 can include artificial intelligence algorithms, machine learning algorithms, neural network algorithms, reinforcement learning algorithms, among other algorithms. In some examples, the artificial intelligence system 104 can include an artificial intelligence voice platform 140, one or more large language models 142 (LLMs), one or more large multimodal models (LMMs), one or more algorithms, text-to-speech generators 144, speech-to-text platforms 146, among other systems. In some examples, the artificial intelligence voice platform 140 can be provided by VAPI company, the LLMs 142 can be provided by OpenAI company, the text-to-speech generator 144 can be provided by ElevenLabs company, and the speech-to-text platform 146 platform can be provided by Deepgram company, among other vendors and/or systems. In some examples, a customer engagement platform 148 can connect to the artificial intelligence system 104. In an example, the voice platform 140 can include an agentic AI agent that can interface with the one or more large language models 142 (LLMs), text-to-speech generators 144, speech-to-text platforms 146. In one example, the customer engagement platform 148 can include a software platform provided by Twilio company. In some examples, the customer engagement platform 148 can interact with motor carriers 112 or freight brokers 114 via phone/voice call or SMS/text messaging, among other communication protocols.

In some embodiments, the motor carriers 112 can provide their load preferences to the virtual dispatcher 102 via at least one of the artificial intelligence system 104, the engagement platform 148, or the computing devices 108 or 138. In some examples, the motor carriers 112 can interact with the artificial intelligence system 104 via the customer engagement platform 148. The customer engagement platform 148 can include an interface for phone/voice calls and/or SMS/text messaging. In some examples, the artificial intelligence system 104 can receive the phone/voice call or SMS/text messaging via the customer engagement platform 148 on behalf of the virtual dispatcher 102, and during the phone/voice call or SMS/text messaging, the artificial intelligence system 104 can receive the load preferences of the motor carriers 112 as input. In some examples, the artificial intelligence system 104 can receive the voice/phone call and/or SMS/text messaging from the motor carriers 112 to collect load preferences in preparation for the next load of the motor carrier 112. In some embodiments, the artificial intelligence system 104 can provide load information to the motor carriers 112 via the customer engagement platform 148. In some examples, the artificial intelligence system 104 can provide motor carrier information to the freight brokers 114 or receive load information from the freight brokers 114 via the customer engagement platform 148. The phone/voice calls can include an audio-based communication between the motor carriers 112 and/or freight brokers 114 and the artificial intelligence system 104 via the customer engagement platform 148. Alternatively, and/or in addition to phone/voice, the artificial intelligence system 104 can receive SMS/text input and/or instructions from the motor carriers 112 and/or freight brokers 114 via the customer engagement platform 148. In some examples, the artificial intelligence system 104 can receive load preferences from motor carriers 112 and/or load availability and/or load offers from freight brokers 114 via the customer engagement platform 148 as SMS/text input and/or via an audio-based call. The artificial intelligence system 104 can input the load preferences on the behalf of the motor carriers 112 to the virtual dispatcher 102 via a post-a-truck module 128 of the service layer 116 and/or input the load availabilities and/or load offers on behalf of freight brokers 114. The virtual dispatcher 102 can store the load preferences of the motor carriers 112 on the database 106.

In some embodiments, the motor carriers 112 and/or freight brokers 114 can provide load preferences of the motor carriers 112 and/or freight brokers 114 to the virtual dispatcher 102 via the computing devices 108. The motor carriers 112 and/or freight brokers 114 can provide load availability and/or load offers to the virtual dispatcher 102 via the computing devices 108. In some examples, the computing devices 108 can receive text input and/or instructions from the motor carriers 112 and/or freight brokers 114 and provide the input to the virtual dispatcher 102. The computing devices 108 can include a desktop computer, a tablet, a mobile phone, a mobile device, among other devices. The computing devices 108 can include a user interface (UI), e.g., via a browser or an application loaded onto the computing device 108, configured to allow the motor carriers 112 and/or freight brokers 114 to input their information to the virtual dispatcher 102. In some examples, the motor carriers 112 can input their load preferences to the virtual dispatcher 102 via a post-a-truck module 128 of the service layer 116. Instructions to the post-a-truck module 128 can be sent by the computing devices 108 through the application programming interface 118 and service layer 116 of the virtual dispatcher 102. The computing device 108 can include a user interface (UI) 136 for freight brokers to view information about motor carriers and/or to provide information about loads, and/or a motor carrier mobile application 138. In some examples, 138 can refer to a desktop and/or web-based platform along with a carrier mobile application, among other software platforms.

In some embodiments, the artificial intelligence system 104 may process audio input from motor carriers 112 and/or freight brokers 114 through a multi-stage technical pipeline that transforms raw audio signals into actionable dispatch responses. The speech-to-text platform 146 can receive audio signals via the customer engagement platform 148 and convert the audio input into digital text data using one or more AI models. For example, these models can analyze audio waveforms to identify phonemes by processing frequency domain representations of the audio signal and apply probabilistic algorithms to convert phoneme sequences into text strings by evaluating contextual word probabilities. This technical process provides the benefit of enabling the virtual dispatcher 102 to receive load preferences from motor carriers 112 in real-time during phone conversations without requiring manual data entry, thereby reducing data entry errors and improving the speed of load preference collection compared to conventional manual dispatching systems.

The digital text data generated by the speech-to-text platform 146 may then be processed by the LLM 142, which can apply neural network architectures with multiple transformer layers to interpret the semantic meaning of the text. The LLMs 142 can extract structured data fields from the digital text data, including pickup locations, delivery destinations, time windows, equipment requirements, route preferences, and carrier availability information. The extraction process can involve applying named entity recognition algorithms to identify location names, temporal expressions, and equipment types, and applying intent classification algorithms to determine the motor carrier's preferences and constraints. This technical extraction process provides the benefit of automatically structuring unstructured conversational input into database-compatible data fields, eliminating the need for human dispatchers to manually parse and categorize load preference information, thereby reducing processing time and improving data consistency.

After processing the extracted structured data fields, the LLMs 142 in communication with the virtual dispatcher 102 may generate a contextually appropriate dispatch response based on the load preferences and available load information. The dispatch response may then be relayed to the the motor carriers 112 and/or freight brokers 114 in various ways, including via phone call, SMS messaging, email, or user interface. For example, the text-to-speech generators 144 may convert a text response into an synthesized audio output using one or more voice synthesis algorithms that model prosody, intonation, and speech patterns to create natural-sounding voice communications. The voice synthesis algorithms may apply concatenative synthesis or parametric synthesis techniques that generate audio waveforms with appropriate pitch contours, duration patterns, and spectral characteristics to produce human-like audio output. This multi-stage data (e.g., audio) processing pipeline provides the technical benefit of enabling fully automated data communication between the virtual dispatcher 102 and motor carriers 112, allowing the disclosed system to handle multiple simultaneous conversations that would be impractical for human dispatchers to manage, thereby improving scalability and reducing labor costs.

In some embodiments, once load preferences have been received and/or analyzed by the virtual dispatcher 102, the virtual dispatcher 102 can provide the motor carriers 112 with load recommendations or load promotions based on the provided load preferences. In some examples, the virtual dispatcher 102 can provide load recommendations or load promotions via the get-a-load module 130 of the service layer 116. The virtual dispatcher 102, e.g., via the get-a-load module 130, can compare the load preferences provided by the motor carriers 112 against a list of potential loads already provided by the freight brokers 114 and/or load boards or other load sources 110. The list of potential loads, e.g., also referred to herein as potential load information, can be stored on a loads cache 122 which can be continually updated. In some embodiments, the virtual dispatcher 102, e.g., after retrieving load information of one or more loads from the service layer 116, can interface with the AI system 104 to interpret, filter, adjust, evaluate, and/or aggregate load information before returning or sending results to the motor carrier via the customer engagement platform 148 or computing devices 108. The loads cache 122 can be continually updated by a load fetcher 126. The load fetcher 126 can receive updated loads and/or pull loads from the load boards or other load sources 110. The load boards or other load sources 110 can be external to the virtual dispatcher 102. The load aggregators 120 can perform a real-time load look-up 124 to pull the list of potential loads from the load boards or other load sources 110. Based on the comparison between the load preferences and the list of potential loads, the virtual dispatcher 102 can provide load recommendations or load promotions to the motor carriers 112 for their next load. In some embodiments, the load preferences and the list of potential loads can be input into the artificial intelligence system 104 by the virtual dispatcher 102 via one or more prompts 134 and/or called via an application programming interface (API), among other means.

The artificial intelligence system 104 can deliver load recommendations or load promotions to the motor carriers 112 based on load preferences and the list of potential loads provided via the prompts 134. The artificial intelligence system 104 can be configured to receive and/or store input by the virtual dispatcher 102 as prompts 134, or other methods. Based on the prompts 134 or other methods, the artificial intelligence system 104 can be configured to respond to the motor carriers 112 and/or freight brokers 114. In some examples, the artificial intelligence system 104 can perform a search, analysis based on the search, and a determination, to respond to the motor carriers 112 and/or freight brokers 114. The artificial intelligence system 104 can provide the response to the motor carriers 112 and/or freight broker 114 that includes a forecast of efficient loads generated based on the prompt 134 or other methods by the virtual dispatcher 102. The artificial intelligence system 104 can use algorithms or be trained based on real world and/or simulated motor carrier load preferences, load information of one or more loads received from freight brokers, actual carrier load preferences received from motor carriers, among other information. In some examples, the prompts 134 or other methods can be selected, adjusted, tailored, and/or input to optimize a response provided by the artificial intelligence system 104. In some examples, the artificial intelligence system 104 can be configured to contact and/or respond to the motor carriers 112 by performing a phone/voice call or through SMS/text messaging. In some examples, the virtual dispatcher 102 can provide load recommendations or load promotions through the application programming interface 118 and computing devices 108. Thus, the computing devices 108 and/or the artificial intelligence system 104 can be configured to provide the motor carriers 112 with instructions or suggestions for their next load based on their provided load preferences.

In some embodiments, the virtual dispatcher 102 can connect the motor carriers 112 with the freight brokers 114 associated with specific loads to facilitate negotiation, booking, or discussion of those loads. In some embodiments, the virtual dispatcher 102 may be further configured to conduct the negotiation, booking or discussion on behalf of the motor carriers 112 or freight brokers 114. For example, the virtual dispatcher 102, via the AI system 104, can interface with the text-to-speech generators 144 and/or speech-to-text platforms 146 to facilitate communication between the motor carriers 112 and the freight brokers 114 regarding the specific loads or to conduct the negotiation, booking or discussion regarding the loads on behalf of the motor carriers 112 or freight brokers 114. In some embodiments, the motor carriers 112 and freight brokers 114 can be connected through the computing devices 108 and/or customer engagement platform 148. The virtual dispatcher 102 can facilitate such communication or conduct the negotiation, booking or discussion through a phone/voice call (e.g., via an AI voice bot), SMS/text messaging, email, and/or computing devices 108, among other ways of communicating with the motor carriers 112 and freight brokers 114.

In some embodiments, once load preferences of the motor carriers 112 have been received by the virtual dispatcher 102, the virtual dispatcher 102 can provide the load preferences to the freight brokers 114, and the freight brokers 114 can respond to the virtual dispatcher 102 whether the freight brokers 114 have any new loads that match to the load preferences of the motor carriers 112. In some examples, the freight brokers 114 can respond in real-time through the computing devices 108. The new loads provided by the freight brokers 114 can include loads that are not yet already included in the list of potential loads that the virtual dispatcher 102 has access to, e.g., via the stored loads cache 122 or as pulled from the load boards or other load sources 110 by the load aggregator 120. A list of motor carriers 112 can be presented to the freight brokers 114 via the user interface 136 on the computing device 108. In some examples, 136 can refer to a trucklist UI, broker UI and/or broker platform.

In some embodiments, some loads listed on the load boards or other load sources 110 or loads cache 122 can be stale, e.g., may be listed but are already taken by other motor carriers. Thus, upon request by the motor carriers 112, the virtual dispatcher 102 can inform the motor carriers 112 whether certain loads are still available. In some examples, the virtual dispatcher 102 can include a module configured to determine whether a load is still available 132. This module, including an AI agent (e.g., SMS, text-to-voice, and/or voice-to-text agent) can be referred to as an Is-load-still-available module 132. In some embodiments, the virtual dispatcher 102, via the AI system 104, can interface with the text-to-speech generators 144 and/or speech-to-text platforms 146 to communicate with the carrier 112 or broker 114. In some examples, the virtual dispatcher 102 can communicate and/or send/receive instructions from the broker 114 to receive updated load information which may or may not yet be available in the database 106. In some embodiments, to determine whether a particular load is still available, the virtual dispatcher 102 can search through the load cache 122 or load boards or other load sources 110 via the load aggregator 120 and/or communicate with the load boards or other load sources 110 to determine whether the load inquired by the motor carrier 112 is still available. In some embodiments, to determine whether a load is still available, the virtual dispatcher 102 can contact and/or inquire with the freight brokers 114 of the particular load. In some examples, the virtual dispatcher 102 can contact the freight brokers 114 via the artificial intelligence system 104 through a phone/voice call to the freight brokers 114, e.g., via an AI voice bot, SMS/text messaging the freight brokers 114, emailing the freight brokers 114, among other ways of contacting the freight brokers 114, to ask the freight brokers 114 whether the load is still available. Once the particular load is determined to be available so that the load can be run by the motor carriers 112 (e.g., the load is still available), or whether the load is already taken by another motor carrier (e.g., the load is unavailable), the virtual dispatcher 102 can contact the motor carriers 112 to inform them whether the load is available to be run by them or not. The motor carriers 112 can inquire whether a load is available or unavailable through the computing devices 108 or via a phone/voice call or SMS/text messaging through the artificial intelligence system 104 and/or customer engagement platform 148.

In some embodiments, the virtual dispatcher 102 may select optimal communication channels for interacting with motor carriers 112 and freight brokers 114 based on user preferences, message urgency, and channel availability. The disclosed system maintains a communication preference profile for each motor carrier 112 and freight broker 114, storing preferred communication channels (e.g., phone call, SMS, email, web application, mobile notification) and channel availability schedules (e.g., phone calls accepted 8 AM-6 PM, SMS accepted 24/7). When the virtual dispatcher 102 needs to communicate with a motor carrier 112 or freight broker 114, the disclosed system queries the communication preference profile and selects the highest-priority available channel.

For phone call communications, the disclosed system can establish a voice connection via the customer engagement platform 148, process audio input through the speech-to-text platform 146 to convert spoken input into digital text, process the digital text through the large language models 142 to generate appropriate dispatch responses, convert the response text into synthesized speech through the text-to-speech generator 144, and transmit the speech to the user. For SMS communications, the disclosed system can transmit text messages via the customer engagement platform 148, receive text responses, and process the text responses through the large language models 142 to extract structured information and generate appropriate reply messages. For email communications, the disclosed system can generate formatted email messages containing load recommendations or load availability information and transmits the emails via standard email protocols (SMTP). For web application communications, the disclosed system can transmit structured data to the computing devices 108 via the application programming interface 118, and the computing devices 108 render the data in user interface components (e.g., tables, lists, forms) for display to the user.

The multi-modal communication channel management mechanism disclosed herein provides the technical benefit of adapting communication methods to user preferences and situational constraints, improving message delivery success rates and user satisfaction. For example, urgent load availability notifications may be delivered via phone call to ensure immediate user attention, while routine load recommendations may be delivered via email or web application to avoid interrupting the user's workflow. The disclosed system's ability to seamlessly switch between communication channels based on context provides improved flexibility compared to conventional dispatching systems that rely on a single communication channel (e.g., phone calls only), thereby improving system accessibility and performance.

### Methods for Automated Dispatch of and Load Assignment for Motor Carriers

Referring to FIGS. 2A and 2B, a method for dispatching and assigning loads to motor carriers 200 is shown, according to some embodiments. At step 202, the method can include receiving, by a virtual dispatcher, load preferences of a motor carrier. In some examples, the load preferences can be received from the motor carrier via an audio call and/or text input. At step 204, the method can include receiving, by the virtual dispatcher, potential load information from a freight broker. In some examples, the potential load information can be received from the freight broker via an audio call and/or text input. At an optional step 206, the method can include storing, by the virtual dispatcher, the load preferences and/or the load information into a database. At step 208, the method can include comparing, by the virtual dispatcher and/or an artificial intelligence system, the load preferences and the potential load information to determine load recommendations for the motor carrier. In some examples, the load recommendations can include recommended goods to be transported by the carrier based on their provided load preferences. In some embodiments, step 208 can include comparing the load preferences to the potential load information stored on a load cache. In one example, a load fetcher can receive updated loads and/or pull loads from load boards, e.g., external load boards, or other sources of loads to update the potential load information. In some examples, step 208 can include using load aggregators to perform a real-time load look-up to pull the potential load information from the load boards or other sources of loads. At an optional step 210, the method can include providing, by the virtual dispatcher and/or an artificial intelligence system, the load preferences to the freight broker to determine load possibilities for the motor carrier. At an optional step 212, the method can include receiving, by the virtual dispatcher and/or an artificial intelligence system, load availability and/or load offers from the freight broker. At step 214, the method can include relaying, by the artificial intelligence system and/or computing devices, the load recommendations, load availability, and/or load offers to the motor carrier. At an optional step 216, the method can include connecting the motor carrier with the freight broker to negotiate, book or discuss the loads. In some examples, step 216 can include the virtual dispatcher negotiating, booking or discussing the loads on behalf of the motor carrier or freight broker. In some examples, the load recommendations, load availability, and/or load offers can be relayed via an audio call and/or text. In some embodiments, step 202 and 204 can be performed sequentially as shown. In some examples, instead of step 204 being performed subsequent to step 202, step 204 can be performed prior to step 202. In some embodiments, steps 202 and 204 can be performed in parallel where both steps 202 and 204 both output into step 206 and 208. For example, both steps 202 and 204 can store information into a database via step 206. Furthermore, the output from the steps 202, 204 and/or step 206 can be input to step 208. In some examples, the system 100 from FIG. 1 can be configured to perform the methods described herein. In an example, the system 100 of FIG. 1 can perform the steps described above from the method 200.

In some embodiments, the method for automated load assignment and/or dispatch for motor carriers can include (i) providing, a virtual dispatcher having a plurality of modules, each module configured to interface with an artificial intelligence (AI) system to perform a task specific to each module, (ii) receiving, using the virtual dispatcher, load preferences from a motor carrier and load information from a freight broker, optionally (iii) selecting, by the virtual dispatcher, at least one module of a plurality of modules using the load preferences, the load information, and AI system, (iv) determining, using the virtual dispatcher, a load assignment using the load preferences, the load information, and the AI system that interfaces with the virtual dispatcher, (v) generating, using the virtual dispatcher, a dispatch response using the load assignment and the AI system, (vi) relaying, using the virtual dispatcher, the dispatch response to the motor carrier, and optionally (vii) connecting, using the virtual dispatcher, the motor carrier with the freight broker to negotiate, book or discuss the loads. In some examples, the method for automated load assignment and/or dispatch for motor carriers does not require the motor carrier to accept the load assignment and haul the load.

In some embodiments, the method for automated load assignment and/or dispatch for motor carriers can include providing load recommendations to motor carriers. For example, the method for automated load assignment and/or dispatch for motor carriers can include (i) providing, a virtual dispatcher having a plurality of modules, each module configured to interface with an artificial intelligence (AI) system, (ii) receiving, using the virtual dispatcher, load preferences from a motor carrier and load information from a freight broker, where the load preferences can include a list of shipping and route details preferred by the motor carrier, optionally (iii) selecting, by the virtual dispatcher, at least one module of a plurality of modules using the load preferences, the load information, and AI system, (iv) determining, using the virtual dispatcher, a load recommendation using the load preferences, the load information, and the AI system that interfaces with the virtual dispatcher, (v) generating, using the virtual dispatcher, a dispatch response using the load recommendation and the AI system, (vi) relaying, using the virtual dispatcher, the dispatch response to the motor carrier, and optionally (vii) connecting, using the virtual dispatcher, the motor carrier with the freight broker to negotiate, book or discuss the loads. In some examples, determining the load recommendation can include matching a motor carrier to the load. In some examples, the method for automated load assignment and/or dispatch for motor carriers does not require the motor carrier to accept the load recommendation and haul the load.

In some embodiments, the method for automated load assignment and/or dispatch for motor carriers can include providing load promotions to motor carriers. For example, the method for automated load assignment and/or dispatch for motor carriers can include (i) providing, a virtual dispatcher having a plurality of modules, each module configured to interface with an artificial intelligence (AI) system, (ii) receiving, using a virtual dispatcher, load information from a freight broker and load preferences from the motor carrier, where the load information can include at least one load which the freight broker is interested to promote to the motor carriers, optionally (iii) selecting, by the virtual dispatcher, at least one module of a plurality of modules using the load preferences, the load information, and AI system, (iv) determining, using the virtual dispatcher, a load promotion using the load preferences, the load information, and the AI system that interfaces with the virtual dispatcher, (v) generating, using the virtual dispatcher, a dispatch response using the load promotion and the AI system, (vi) relaying, using the virtual dispatcher, the dispatch response to the motor carrier, and optionally (vii) connecting, using the virtual dispatcher, the motor carrier with the freight broker to negotiate, book or discuss the loads. In some examples, determining the load promotion can include matching a load to the load preferences of the motor carrier. In some examples, the method for automated load assignment and/or dispatch for motor carriers does not require the motor carrier to accept the promoted load and haul the load.

The system 100 of FIG. 1 can perform the methods for automated load assignment and/or dispatch for motor carriers described above.

### Improvements Over Other Motor Carrier Dispatch Systems and Methods

The systems and methods presented herein provide an improvement over conventional dispatching systems by providing automated load recommendations to motor carriers based on received load preferences of the motor carriers and facilitated negotiation, booking or discussion of those loads. The systems and methods presented herein provide a virtual dispatcher that improves on the manual operation and management of conventional dispatching systems by automatically: (1) receiving load preferences from motor carriers via an audio call, SMS/text messaging, text input or computing device, (2) receiving potential loads from freight brokers and preparing a list of potential loads based on the received potential loads from the freight brokers, (3) storing the load preferences and the list of potential loads onto a datastore such as a database, (4) analyzing and/or comparing the load preferences to the list of potential loads, (5) determining next load recommendations for the motor carrier based on the analysis and comparison, (6) providing the load recommendation to the motor carriers via an audio call, text, or computing device, and (7) potentially connecting the motor carrier to the freight broker to negotiate, book, or discuss the load, including, in some instances, the virtual dispatcher conducting the negotiation, booking or discussion of the load on behalf of the motor carrier or freight broker. Furthermore, the systems and methods presented herein remove the opportunity for human error, and provide a system that is scalable to handle a multitude of motor carriers and/or freight brokers that would not have been practical to be handled by human dispatchers of conventional systems. The systems and methods can process requests and provide load recommendations that would not be practically possible to be performed by human dispatchers of the conventional systems. For example, the system can contact, communicate with, request instructions from, and/or receive load/carrier information from multiple motor carriers and/or freight brokers simultaneously to determine load assignments or load availability or to negotiate or book loads, which could not be practically performed by human dispatchers of the conventional systems. In contrast, traditional systems would be limited to manually calling carriers and brokers sequentially, e.g., not in parallel.

As discussed below, one or more hardware and software systems can be used in implementing the systems and methods described above.

### Hardware and Software Implementations

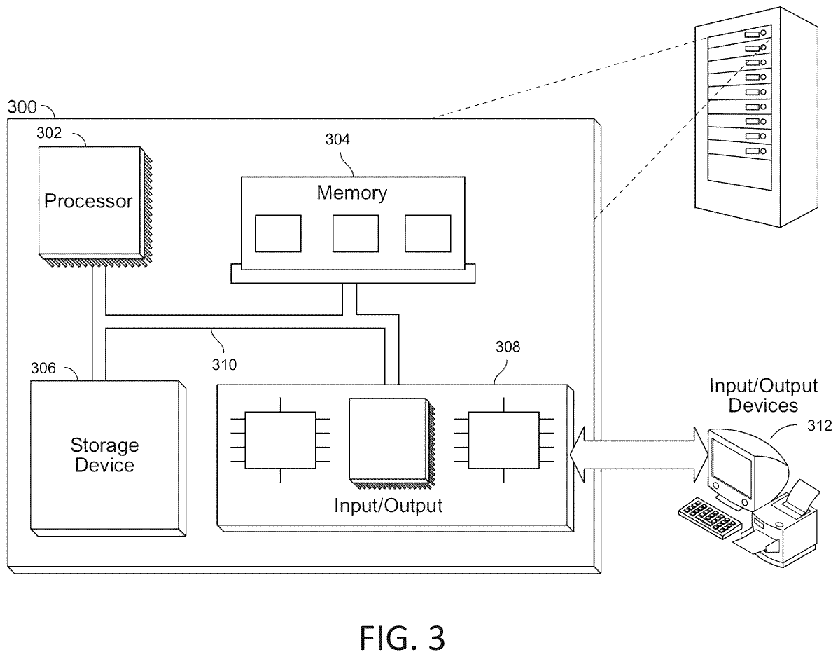

FIG. 3 is a block diagram of an example computer system 300 that may be used in implementing the technology described in this document. General-purpose computers, network appliances, mobile devices, or other electronic systems may also include at least portions of the system 300. The system 300 includes a processor 302, a memory 304, a storage device 306, and an input/output device 308. Each of the components 302, 304, 306, and 308 may be interconnected, for example, using a system bus 310. The processor 302 is capable of processing instructions for execution within the system 300. In some implementations, the processor 302 is a single-threaded processor. In some implementations, the processor 302 is a multi-threaded processor. The processor 302 is capable of processing instructions stored in the memory 304 or on the storage device 306.

The memory 304 stores information within the system 300. In some implementations, the memory 304 is a non-transitory computer-readable medium. In some implementations, the memory 304 is a volatile memory unit. In some implementations, the memory 304 is a non-volatile memory unit.

The storage device 306 is capable of providing mass storage for the system 300. In some implementations, the storage device 306 is a non-transitory computer-readable medium. In various different implementations, the storage device 306 may include, for example, a hard disk device, an optical disk device, a solid-date drive, a flash drive, or some other large capacity storage device. For example, the storage device may store long-term data (e.g., database data, file system data, etc.). The input/output device 308 provides input/output operations for the system 300. In some implementations, the input/output device 308 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 312. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 306 may be implemented in a distributed way over a network, for example as a server farm or a set of widely distributed servers, or may be implemented in a single computing device.

Although an example processing system has been described in FIG. 3, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; and magneto optical disks. The processor and the memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention.

What is claimed is:

1. A method for automated load assignment and/or dispatch for motor carriers, the method comprising:
providing, a virtual dispatcher having a plurality of modules, each module configured to interface with an artificial intelligence (AI) system to perform a task specific to each module;
receiving, at the virtual dispatcher, load preferences from a motor carrier and load information from a freight broker;
determining, using the virtual dispatcher, a load assignment using the load preferences, load information, and the AI system that interfaces with the virtual dispatcher;
generating, using the virtual dispatcher, a dispatch response using the load assignment and the AI system; and
relaying, using the virtual dispatcher, the dispatch response to the motor carrier.

2. The method of claim 1, wherein the AI system comprises at least one of a large language model (LLM), a large multimodal model (LMM), or an algorithm.

3. The method of claim 1, further comprising:
selecting, by the virtual dispatcher, at least one module of the plurality of modules using the load preferences, load information, and AI system, wherein the selecting is performed prior to determining the load assignment, and the at least one selected module is used to perform at least the step of determining the load assignment.

4. The method of claim 3, further comprising:
comparing, by at least one of the AI system and a selected module of the virtual dispatcher, the load preferences with a list of potential loads; or
comparing, by the at least one of the AI system and the selected module of the virtual dispatcher, the load information with a list of potential carriers,
wherein determining the load assignment is based on comparisons associated with the load preferences and the load information.

5. The method of claim 4, further comprising:
retrieving, by the selected module of the virtual dispatcher, the list of potential loads from at least one of a load board or a load source; and
interfacing, by the selected module of the virtual dispatcher, with the AI system to interpret, filter, adjust, evaluate, and aggregate the load information before relaying the dispatch response to the motor carrier.

6. The method of claim 4, further comprising:
identifying, by the at least one of the AI system and the selected module of the virtual dispatcher, one or more loads from the list of potential loads that is available for delivery based on the comparisons.

7. The method of claim 3, further comprising:
determining, by the AI system, availability of the motor carrier; and
storing, by at least one of the AI system and the selected module of the virtual dispatcher, the load preferences including the availability of the motor carrier to a database.

8. The method of claim 3, wherein the at least one module comprises a load aggregator, and the method further comprises generating, by the load aggregator, a list of potential loads from load sources.

9. The method of claim 1, further comprising connecting, using the virtual dispatcher, the motor carrier and the freight broker.

10. The method of claim 9, further comprising:
initiating, by the virtual dispatcher, a communication session between the motor carrier and the freight broker through at least one of a phone call, a short messaging service (SMS) message, an email, or a computing device interface; and
facilitating, using at least one of the virtual dispatcher and the AI system, real-time communication between the motor carrier and the freight broker to negotiate, book, or discuss the load assignment.

11. The method of claim 1, further comprising:
receiving audio input by at least one of the virtual dispatcher and the AI system, wherein the audio input includes at least one of the load preferences and load information;
processing, by at least one of the virtual dispatcher and the AI system, the audio input to generate the dispatch response;
converting the dispatch response into audio information; and
transmitting the audio information to at least one of the motor carrier or the freight broker.

12. The method of claim 1, further comprising:
providing, by the virtual dispatcher, at least the load preferences to the AI system via one or more prompts; and
receiving, from the AI system, load recommendations generated based on the prompts,
wherein the dispatch response is generated based on the load recommendations.

13. The method of claim 1, wherein the load preferences comprise at least one of a carrier pick-up schedule, a carrier equipment, a carrier origin location, a preferred delivery destination, pickup location, pick up time, load type, possible destination, or a carrier route preference.

14. The method of claim 1, wherein the load information comprises at least one of a load pick-up schedule, a load delivery schedule, a load origin, a load destination, a load type, or a load payment offer.

15. A system for automated load assignment and/or dispatch for motor carriers, the system comprising:
a virtual dispatcher having a plurality of modules, each module configured to interface with an artificial intelligence (AI) system to perform a task specific to each module, wherein the virtual dispatcher is configured to:
receive load preferences from a motor carrier and load information from a freight broker;
determine a load assignment using the load preferences, load information, and the AI system that interfaces with the virtual dispatcher;
generate a dispatch response using the load assignment and the AI system; and
relay the dispatch response to the motor carrier.

16. The system of claim 15, wherein the AI system comprises at least one of a large language model (LLM), a large multimodal model (LMM), or an algorithm.

17. The system of claim 15, wherein the virtual dispatcher is further configured to select at least one module of the plurality of modules using the load preferences, load information, and AI system, wherein the selecting is performed prior to determining the load assignment, and the at least one selected module is used to perform at least the step of determining the load assignment.

18. The system of claim 15, wherein the virtual dispatcher is further configured to connect the motor carrier and the freight broker.

19. The system of claim 18, wherein the virtual dispatcher is further configured to
initiate a communication session between the motor carrier and the freight broker through at least one of a phone call, a short messaging service (SMS) message, an email, or a computing device interface; and
facilitate real-time communication between the motor carrier and the freight broker to negotiate, book, or discuss the load assignment.

20. The system of claim 15, wherein the virtual dispatcher is further configured to:
provide at least the load preferences to the AI system via one or more prompts; and
receive, from the AI system, load recommendations generated based on the prompts, wherein the dispatch response is generated based on the load recommendations.
